(19) United States
(12) Patent Application Publication
(10) Pub. No.: US 2025/0040490 A1
(43) Pub. Date: Feb. 6, 2025

(54) PLANT EXTRACTION SYSTEMS AND METHODS OF USE

(71) Applicant: T.O. Plastics, Inc., Clearwater, MN (US)

(72) Inventors: David J. Callicott, South Haven, MN (US); Scott J. Klein, South Haven, MN (US)

(21) Appl. No.: 18/779,179

(22) Filed: Jul. 22, 2024

Related U.S. Application Data
(60) Provisional application No. 63/517,766, filed on Aug. 4, 2023.

(51) Int. Cl. A01G 9/029; B65D 1/36

(52) U.S. Cl. CPC A01G 9/0299; A01G 9/0297; B65D 1/36

(57) ABSTRACT

An extraction system for extraction of planting material from a plurality of planting cells of a tray includes a carriage with a base, a frame arranged atop the base, and a plurality of compressible frame supports joined therebetween. A pin board with a plurality of pins joined to a base thereof is releasably securable to the base of the carriage. The carriage frame and base are movable relative to one another from a first position to a second position, and in the first position, the frame receives and supports the tray above the plurality of pins of the pin board, and during movement to the second position, the pins to enter a cell opening of each of the planting cells, extend into the planting cells to thereby contact the planting material therein, and force the planting material out of an open end of each of the plurality of planting cells.

### CROSS-REFERENCE TO RELATED APPLICATIONS

This application claims priority to U.S. Provisional Patent Application No. 63/517,766, filed Aug. 4, 2023, entitled “Plant Extraction Systems and Methods of Use,” which is incorporated by reference herein, in its entirety and for all purposes.

### TECHNICAL FIELD

Disclosed are extraction systems and methods for use in planting operations, and more particularly, disclosed are extraction systems including a carriage and pin board used to extract plugs of planting material from a seedling tray.

### BACKGROUND

Plug trays and seedling trays typically contain planting material including plug media and seeds or seedlings growing therefrom. As root structures develop in the cells of the tray and the tray undergoes repeated watering operations over time, the plug media attaches to the interior walls of the cells, resulting in difficulties in removal of the plug media from the trays such as separation of the seedling plants from their root structure, both of which may be delicate and easily separable if a user pulls the plants while the plug media is securely attached to the cell walls of the tray. In prior approaches, the plug media was loosened from the trays by a user gently pulling the plants individually, which can be time-consuming and labor-intensive. In some cases, a peg board may be placed under the tray and the user may press the bottom of the tray against pegs of the peg board in an effort to force the plugs out of the cells, however the use of peg boards presents challenges as it is highly difficult to achieve proper alignment when using a peg board by itself. Particularly, extraction or popping plugs out with uniformity and without damaging the plant or tray can be challenging when using peg board by itself. In addition, the efficiency of extraction processes is substantially lower when using the peg board alone.

### SUMMARY

These limitations as well as limitations of prior extraction systems are overcome by providing the extraction systems of the present disclosure.

According to certain implementations, an extraction system may include: a carriage including a base, a frame arranged atop the base, and a plurality of compressible frame supports joined between the base and the frame; and a pin board including a plurality of pins joined to a base of the pin board, the pin board configured to be releasably secured to the base of the carriage. The carriage may be configured such that the frame and the base of the carriage are movable relative to one another from a first position to a second position in which the compressible frame supports are compressed. During movement from the first position to the second position, the pins of the pin board may be configured to force planting material out of an open end of each of a plurality of planting cells of a tray held by the frame.

In various implementations and alternatives, in the first position of the carriage, the frame may be configured to slidably receive the tray between at least one first support rib and at least one second support rib of the frame, where the at least one first support rib and the at least one second support rib is joined to a length of the frame and extends along a width of the frame, and at least one of the first support rib or the second support rib may be adjustably positionable. In such implementations and alternatives, one or more releasable fasteners may join the frame to the at least one adjustably positionable support rib such that the adjustably positionable support rib may be movably adjustable along the length of the frame. In addition or alternatively, the at least one adjustably positionable support rib may be height-adjustable relative to the frame, and or may be telescopic and configured to have an adjustable length.

In various implementations and alternatives, the pin board may be a first pin board, and the plurality of pins of the first pin board are non-removably fixed to the base of the first pin board, and the extraction system may include at least a second pin board configured to be releasably secured to the base of the carriage, the second pin board including a plurality of pins non-removably fixed to a base of the second pin board, and a configuration of the pins of the first pin board differ from a configuration of the pins of the second pin board.

In various implementations and alternatives, the pin board may include a plurality of openings configured to removably receive the plurality of pins.

In various implementations and alternatives, the base of the pin board may include one of a securing feature or a securing region, and the base of the carriage may include another of the securing feature or the securing region, and the securing feature and the securing region may cooperate to secure the pin board to the base. In addition or alternatively, the base of the pin board may include a first positioning feature and the base of the carriage may include a second positioning feature, and the first positioning feature and the second positioning feature may be configured to engage to aid in positioning the pin board within the carriage.

In various implementations and alternatives, the compressible frame supports may be fixedly arranged on the base and slidably arranged on the frame such that the frame is movable towards the base during movement from the first position to the second position.

According to other implementations, a method of using an extraction system, may involve, at a carriage, releasably securing a pin board on a base of the carriage in a first position of the carriage, where the carriage may include a frame arranged atop the base, and a plurality of compressible frame supports joined between the base and the frame, and where the pin board may include a plurality of pins joined to a base of the pin board, and where the plurality of compressible frame supports are uncompressed in the first position of the carriage. Then compressing the compressible frame supports such that the frame and the base are move relative to one another from the first position to a second position, where during compressing, the pins of the pin board may force planting material out of an open end of each of a plurality of planting cells of a tray held by the frame of the carriage upon reaching the second position.

In various implementations and alternatives, while the carriage is in the first position, the method may further involve slidably inserting the tray between at least one first support rib and at least one second support rib of the frame, the at least one first support rib and the at least one second support rib joined to a length of the frame and extending along a width of the frame; and adjustably positioning at least one of the first support rib or the second support rib for instance as described above. Various implementations and alternatives described above in connection with the extraction system may also be used in connection with the method of using the extraction system.

### BRIEF DESCRIPTION OF THE DRAWINGS

FIG. 1A shows a front right isometric view of an extraction system holding a planting tray in a first position of the extraction system, according to certain implementations.

FIG. 1B shows the extraction system in which the pin board is removed from the carriage, according to certain implementations.

FIG. 2A shows a front right isometric view of the carriage of the extraction system, according to certain implementations.

FIG. 2B shows a back view of the carriage of the extraction system, according to certain implementations.

FIG. 3 shows a front right isometric view of the pin board of the extraction system, according to certain implementations.

FIG. 4A shows a front right isometric view of a tray that may be used in the extraction system, according to certain implementations.

FIG. 4B shows a detail view of planting cells of the tray.

FIG. 5A shows a front right isometric view of the extraction system prior to insertion of the planting tray.

FIG. 5B shows a front right isometric view of an extraction system holding a planting tray in a second position of the extraction system, according to certain implementations.

FIG. 5C shows a detail view of the extraction system and the tray in the first position of FIG. 1A.

FIG. 5D shows a detail view of the extraction system and the tray in the second position of FIG. 5B.

### DETAILED DESCRIPTION

Disclosed are extraction systems and methods for the simultaneous extraction of a plurality of plants growing in plugs from a seedling tray, which may be useful in agricultural, horticultural, and/or home growing operations. Seedling trays generally include a plurality of planting cells, and as further provided herein, each planting cell may be filled with an amount planting material, e.g., plug media and seed such that a seedling grows therefrom. Seedling trays are also referred to as plug trays, and are generally referred to herein as trays. As provided herein, the extraction systems of the present disclosure may be used in extraction processes where plugs of planting material are simultaneously dislodged from the tray.

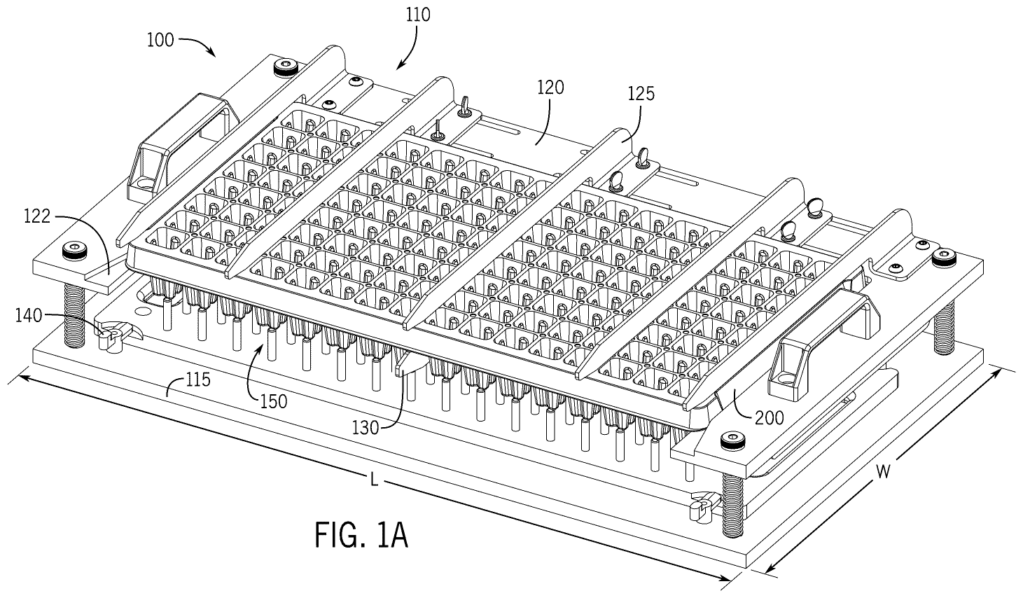

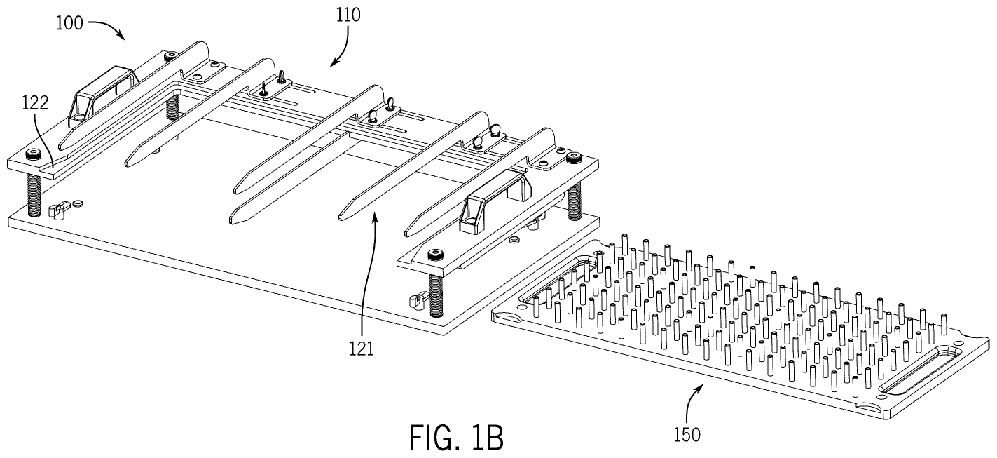

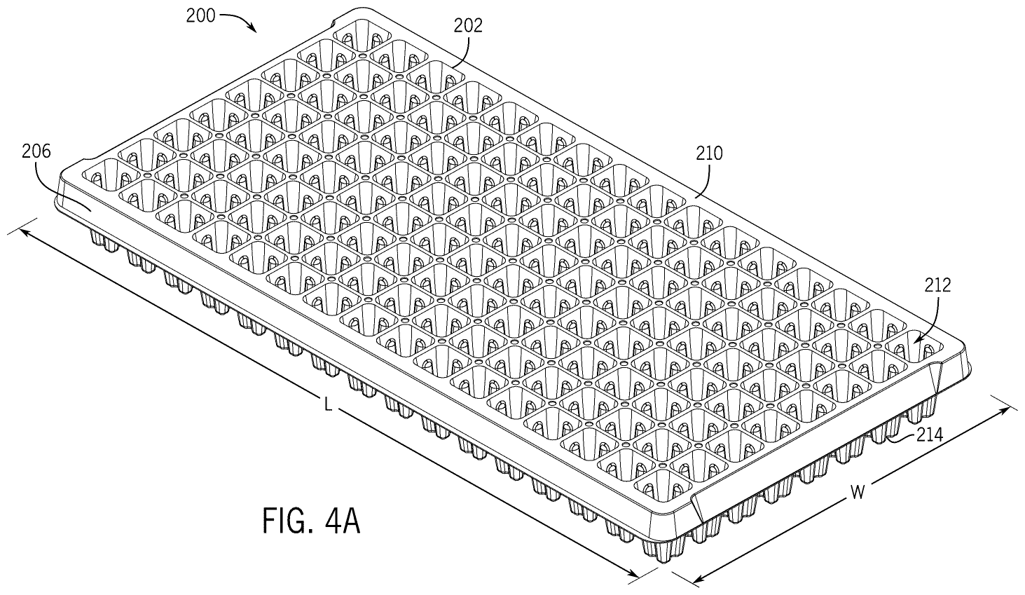

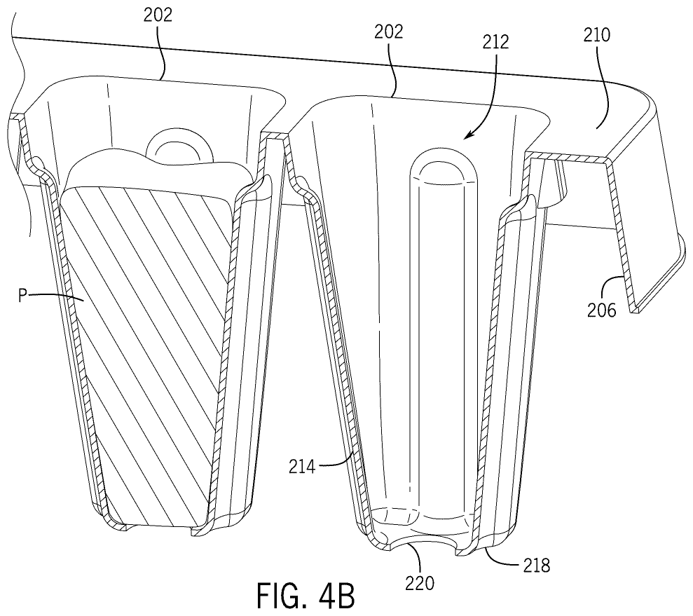

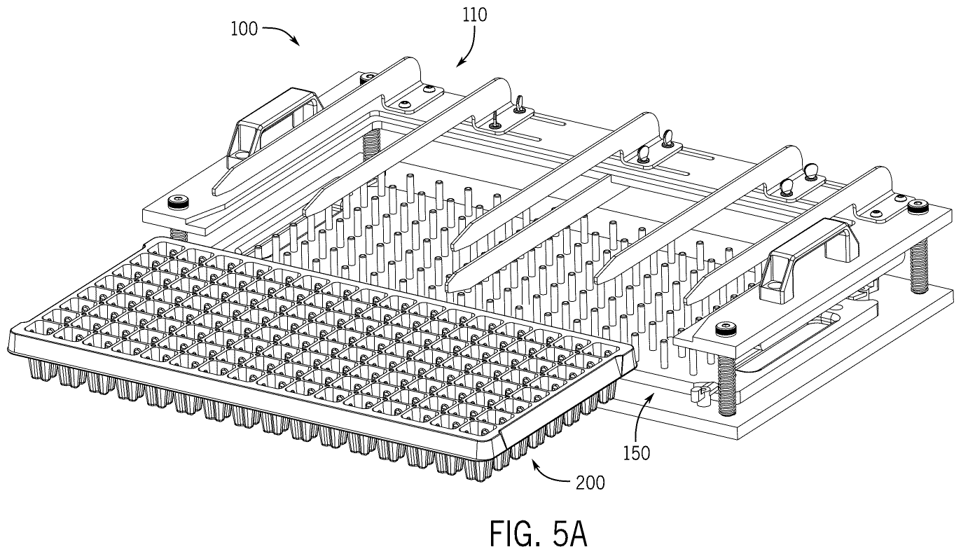

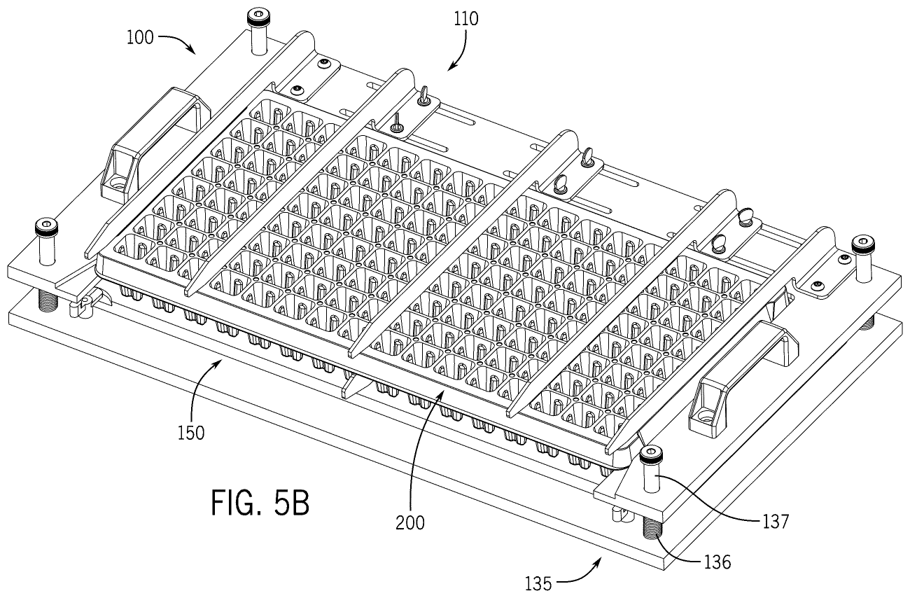

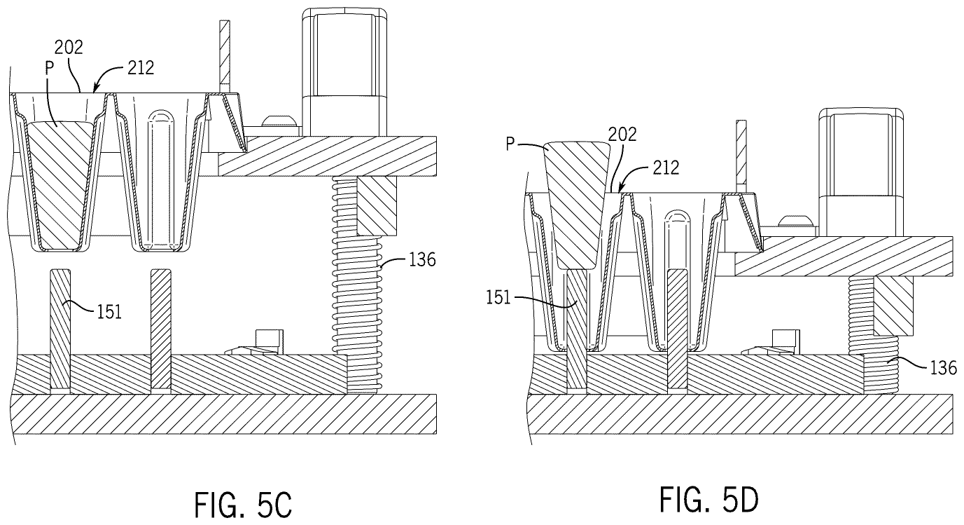

Referring to FIGS. 1A and 1B, an extraction system 100 may include a carriage 110 and pin board 150 removable therefrom. The carriage 110 may receive a tray 200 having a plurality of planting cells each containing a plug of planting material P (FIG. 4B), e.g., plug media with a plant growing therefrom, and the carriage 110 and pin board 150 may be movable relative to one another from a first position (FIG. 1A) to a second position (FIG. 5B) during an extraction process in which the plurality of plugs of planting material P are dislodged simultaneously from the planting tray 200. The carriage 110 may removably receive the pin board 150 (FIG. 1B), enabling the system 100 to receive pin boards having various configurations. The system 100 enables the plugs of planting material P to be easily released from the tray 200 to facilitate removal and transplanting of the plugs of planting material P, which may be useful for professional growers and home growers alike.

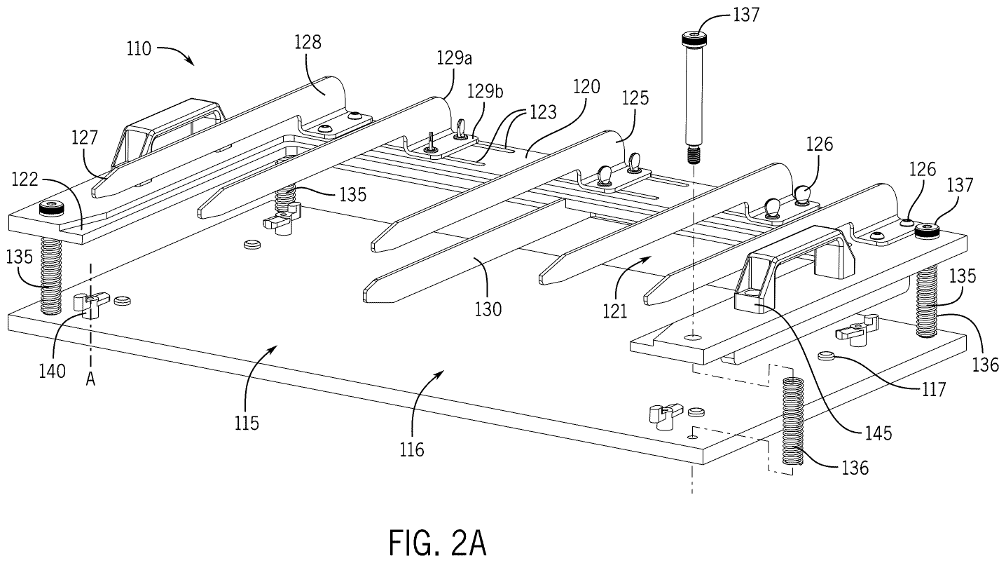

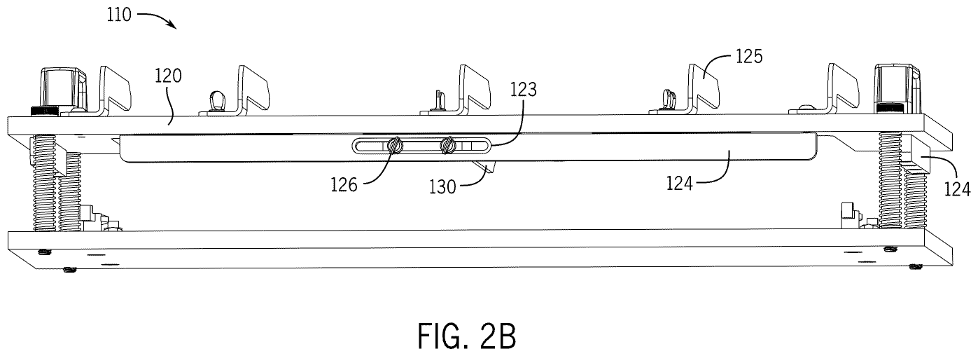

FIGS. 2A and 2B illustrate the carriage 110 of the extraction system 100 according to the present disclosure. The carriage 110 may include a base 115, a frame 120, one or more first support ribs 125, one or more second support ribs 130, compressible frame supports 135, one or more securing features 140, and one or more handles 145. The carriage 110 may be configured to receive the pin board 150 and the plug tray 200 (FIG. 1A). For instance, the pin board 150 may be inserted into or onto the base 115 of the carriage 110, while the plug tray 200 may be inserted between the first and second support ribs 125, 130 prior to an extraction operation. The components of the carriage 110 may generally be constructed of rigid materials, such as industrial materials, and non-limiting examples include high-density polyethylene, polycarbonate, metal (e.g., aluminum, steel), wood products (e.g., solid wood, particle board, plywood), carbon fiber, ceramics, composite materials, and combinations thereof.

The base 115 of the carriage 110 may generally be configured to provide support to components of the extraction system 100 and to rest atop a support surface, e.g., a table or working surface. The compressible frame supports 135 may be joined to the base 115 in areas proximate an outer perimeter of the base 115, such as at the corners of the base 115, and may be configured to join the base 115 to the frame 120 to permit relative movement therebetween, as provided further herein. The securing features 140 may be joined to the base 115 for use in securing the pin board 150 to the base 115 of the carriage 110. The securing features 140 may be arranged in areas proximate an outer perimeter of the base 115, such as at the corners. The base 115 may include a receiving region or surface 116 for removably receiving the pin board 150. The receiving region or surface 116 may include positioning features 117 such as dowel pins or recesses or other openings for locating with complementary features of the pin board 150, as provided herein.

Although the base 115 is illustrated as having a rectangular shape, the base 115 and receiving region or surface 116 may include other configurations adapted to receive the pin board 150 such as a square, oval, or a shape adapted to receive the pin board 150. For instance, the receiving region or surface 116 may include a cutout so that the base 115 and the pin board 150 received therein may be supported by a common support surface, e.g., a table. For instance, the receiving region or surface 116 may include a configuration similar to an interior region 121 of the frame 120 as described herein. Alternatively, the base 115 may be supported by the support surface, while the pin board 150 is supported by the receiving region or surface 116 of the base 115 as shown in FIG. 1A.

In addition, although the base 115 is illustrated as having a unitary construction, the base 115 may be configured to have multiple parts allowing for an adjustable size base 115 and carriage 110. For instance the base 115 may be width, length and/or height-adjustable. In such implementations, expansion features may be included, such as telescopic support arms, a threaded rod and threaded sleeve, or other coupling structures arranged on opposing surfaces of the base 115 to permit expansion of the base 115 along a length and/or width. Such expansion features may be configured with locking positions to enable the base 115 to maintain a selected size. Height adjustment features of the base 115 may be included for instance as height-adjustable compressible frame supports 135 such as elongated guide rods and springs, or as separate height adjustment features, such as adjustable legs extending from a bottom face of the base 115, spacers, and combinations thereof. Height adjustment features may be configured with locking positions to enable the base 115 to maintain a selected height. Such configurations may enable the carriage 110 to receive pin boards and trays having various dimensions.

The frame 120 of the carriage 110 may generally be configured to receive the plug tray 200 in cooperation with the support ribs 125, 130 and be movable relative to the base 115 or vice versa. The frame 120 may be supported atop the base 115 by the compressible frame supports 135 in areas proximate an outer perimeter, such as at the corners of the frame 120 as shown. The one or more handles 145 may be received by the frame 120. In some implementations, the frame 120 may have an outer perimeter with a length and width approximately corresponding to the length and width of the outer perimeter of the base 115.

The frame 120 may define an outer perimeter for instance having a rectangular shape, and an interior region 121 defining a cutout adapted to receive the plug tray 200. For instance the interior region 121 may have a rectangular shape, a general c-shape, or another shape corresponding to an exterior perimeter of the plug tray 200.

A recess 122 may be defined in the frame 120 along a perimeter of the interior region 121 and may aid in supporting and positioning the tray 200 once the tray 200 is received in the interior region 121.

Receiving slots 123 may be defined in the frame 120 and may be configured to receive the first and second support ribs 125, 130. The slots 123 may define openings in the frame 120 and extend along a length thereof. Each slot 123 may receive one or more support ribs 125,130. The receiving slots 123 may extend through the frame 120 from first surface to a second surface opposite the first, e.g., from top to bottom or front to back.

Support bars 124 may be joined to or integrally formed by the frame 120 and may provide support and rigidity to the frame 120. One or more receiving slots 123 may be defined in one or more of the support bars 124. For instance, in FIG. 2B a receiving slot 123 may extend through the support bar 124 extending along the length of the frame 120 and may receive one or more support ribs, such as one or more second support ribs 130.

Although the frame 120 is illustrated as having a unitary construction, the frame 120 may be configured to have multiple parts allowing for an adjustable size. For instance the frame 120 may be width, length and/or height-adjustable. In such implementations, expansion features may be included as described herein and may be arranged on opposing surfaces of the frame 120 to permit expansion along a length and/or width. Height adjustment features may be included as described herein, and additionally may include a height-adjustable recess 122. Such configurations may enable the frame 120 to receive trays having various dimensions.

The one or more first support ribs 125 and one or more second support ribs 130 of the carriage 110 may generally have a length that extends along a width of the frame 120 and be configured to support a tray 200 received in the carriage 110. The first support ribs 125 may support a top surface 210 of the tray 200 and the second support ribs 130 may support a skirt 206 of the tray 200 as provided further herein. Any number of support ribs 125, 130 may be provided on the frame 120 such as five first support ribs 125 and one second rib 130, or 1, 2, 3, 4, 5, 6, 7, 8, 10, 15, first and/or second support ribs 125, 130.

The support ribs 125, 130 may be joined to the frame 120 by any suitable fastening mechanism. For instance fasteners 126 may fasten the support ribs 125, 130 to the frame. The fasteners 126 may be fixed or releasably fixed to the frame 120. For instance, fasteners 126 may be configured as thumb screws that may join directly to the frame 120, or may be configured as thumb screws and washers that may be releasably joined together and arranged between opposing surfaces of the slot 123 of the frame 120 to secure one or more support ribs 125, 130 to the frame 120 as shown. Support ribs 125, 130 joined to the frame 120 via slots 123 may be adjustably movable along a length of the frame 120 and may permit the support ribs 125, 130 to be moved relative to each other and relative to the frame 120. For instance the support ribs 125, 130 may positioned to extend between planting cells along a width of a tray upon insertion into the carriage 110. In some implementations, a support rib may be joined to the frame 120 by being joined to two or more positions on the frame 120, such as two or more slots 123 of the frame 120, e.g., at a front and a back of a length of the frame 120, as shown. In some implementations, the fasteners 126 may enable the support ribs 125, 130 to be height-adjustable relative to the frame 120, such as by providing movable supports (e.g., threaded washers) along a length of the fasteners 126 and a support rib be coupled to the movable supports and the first support ribs 125 may for example rest above the frame 120 and/or the second support ribs 130 may rest below the frame 120 via the movable supports, which may permit the system 100 to receive trays 200 having various configurations, such as various skirt 206 heights or trays having planting cells 202 with various depths.

Although the support ribs 125, 130 are shown as having a unitary construction of a fixed length, the support ribs 125, 130 may be configured to have multiple parts allowing for an adjustable length and/or an adjustable height. For instance the support ribs 125, 130 may include a telescopic configuration where a first component of a support rib is slidably received relative to a second component of the support rib, such as two legs that slidably receive the first component, while locking features may lock these components into a selected telescopic position. In one example, a front end 127 of the support rib may telescope relative to a back end 128 of the support rib so that the support rib, e.g., a first support rib 125, has an adjustable length. In another example, a top end 129a of a support rib, e.g., the first support rib 125, may telescope relative to a bottom end 129b of the support rib so that the support rib has an adjustable height relative to the frame 120, e.g., an adjustable clearance height above or below the frame. Such configurations may enable the support ribs 125, 130 and the frame 120 to receive trays 200 having various widths, heights, and optionally lengths when the frame 120 is length-adjustable. In addition or alternatively, different sized support ribs 125, 130 having varying lengths and/or clearance heights relative to the frame 120 may be interchangeable with other support ribs 125, 130. Such configurations may enable the support ribs 125, 130 and the frame 120 to receive trays 200 having various widths, heights, and optionally lengths when the frame 120 is length-adjustable. The support 125, 130 ribs may include a tapered front end 127 to guide insertion of and to support the tray 200 as it inserted into the front or open end of the carriage 110, and may further facilitate separation of plant material P growing from the tray 200.

The compressible frame supports 135 of the carriage 110 may generally be configured to support the frame 120 atop the base 115 and be movable, e.g., compressible, to provide for relative movement between the base 115 and the frame 120. The compressible frame supports 135 may include a compressible support 136 such as a coil spring, and a stationary support 137 such as an elongated guide rod configured to receive the compressible support 136. The stationary support 137 may be non-movably coupled to the base 115, e.g., via a threaded connection, and may be coupled to the frame 120 such that the frame 120 is movable relative to the base 115, e.g., slidably movable. In alternative configurations, the stationary support 137 may be non-movably coupled to the frame 120 and movably coupled to the base 115. The compressible supports 136 may together provide sufficient resistance or potential energy to support the frame 120, the components joined thereto, and a tray 200 arranged in the carriage so that the tray 200 rests above the pin board 150 until a user compresses the compressible frame supports 135 in an extraction operation. In some implementations, each of the compressible supports 136 may have the same resistance or potential energy. Although the compressible frame supports 135 are shown as having a spring and supporting rod arrangement, the compressible frame supports 135 may alternatively be configured with a compressible support that relies on compression of fluid, e.g., oil or air, and a stationary support that permits the flow of such fluid out of and into the compressible frame support 135 during an extraction operation. While the compressible frame supports 135 are illustrated as being arranged at each of the four corners of the carriage 110, the compressible frame supports 135 may be arranged in other locations of and/or additional supports 135 may be provided on the carriage 110. In addition, while the compressible frame supports 135 are illustrated as extending through the frame 120, the frame support may be slidably coupled to the frame 120 via a sleeve joined to the frame 120. Further, the compressible supports 135 may be slidable relative to the base 115 and may be fixed to the frame 120.

The securing features 140 of the carriage 110 may generally be configured to releasably secure a pin board 150 to the base 115 of the carriage. The securing features 140 may be joined movably to the base 115 and arranged proximate the outer perimeter of the base 115, such as at the four corners of the carriage 110 along an edge of the receiving surface or region 116 of the base 115 configured to receive the pin board 150, and may also be located at other locations along the length and the width of the carriage 110 where the pin board is received. The securing features 140 may be configured as latches, such as turn latches that rotate or pivot about an axis A extending perpendicular to the base 115, and for example may be rotatable by about 90, 180 or 360°. The securing features 140 may additionally or alternatively be configured as releasable clips, hooks, clamps, and so on.

The one or more handles 145 of the carriage 110 may generally be configured to be held by a user during an extraction operation. The handles 145 may be joined to or integrally formed by the frame 120. Although the handles 145 are shown as being arranged atop the frame 120, the handles may be arranged along a sidewall of the frame 120. In some examples, the handles 145 may not be present on the carriage 110, or may be removably joined thereto.

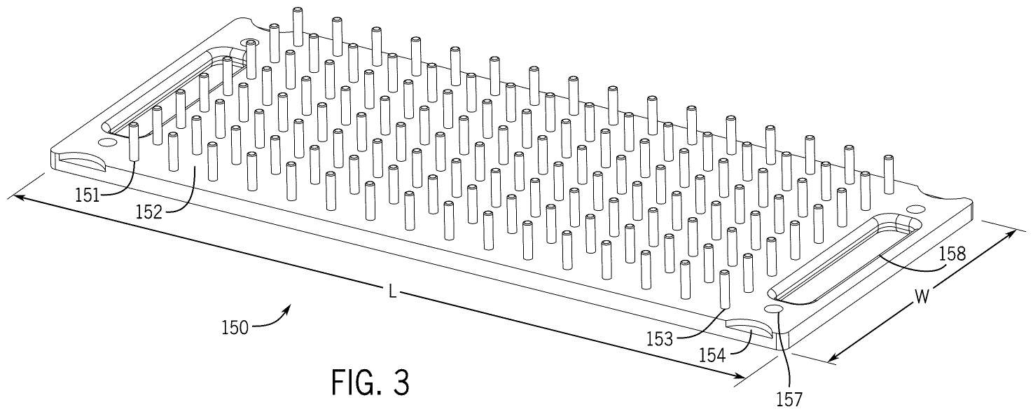

Turning to FIG. 3, the pin board 150 of the extraction system 100 may generally be configured to be received in the carriage 110 at the base 115 and may facilitate extraction of plugs from the plug trays 200 during an extraction operation. The pin board 150 may include pins 151, a base 152, openings 153, securing regions 154, positioning features 157, and handles 158.

The pin board 150 may have a generally rectangular shape, and may be received at the receiving surface or region 116 of the base 115. The pin board 150 may include a plurality of pins 151 joined thereto and positioned to correspond to openings defined in each of a plurality of planting cells 202 of a plug tray 200 as provided herein. The pins 151 may be rigid, non-compressible projections arranged on a base 152 of the pin board 150 and may extend towards the frame 120 of the carriage 110 when positioned therein. The pins 151 may be fixedly joined to the base 152, e.g., non-removable, or may be removable to, for instance, permit the pins 151 of various heights and diameters to be arranged over the base 152 to enable various configurations of the plug tray 200 to be received by the system 100.

The base 152 of the pin board 150 may define a main body of the pin board 150 and a plurality of openings 153 may be configured to receive the pins 151. In some implementations, the base 152 may define a pre-defined number of openings 153 and receive pins 151 therein according to the number of planting cell openings 220 within a given configuration of tray 200. For instance, FIG. 1A illustrates a pin board 150 with 128 pins 151 and openings 153 and may be used in combination with a tray 200 having 128 planting cell openings 220. In other non-limiting examples, 10-600 pins 151 and openings 153 of the pin board 150 may be provided where the tray 200 includes the respective number of planting cell openings, such as 10, 40, 50, 60, 72, 98, 128, 162, 242, 512 openings 153 and pins 151, and the pin board 150 may be configured to or be modified to fit existing and future plug tray configurations. In some implementations, the base 152 and pins 151 may be configured to permit removal and replacement of the pins 151 in selected positions of the base 152, e.g., where the base 152 has peg board configuration, so that the pins 151 are removably insertable into the openings 153 based on one of various configurations of a tray 200.

The pin board 150 may optionally include one or more securing regions 154 where the pin board 150 may be releasably secured to the carriage 110 by the securing features 140. The securing regions 154 may be arranged at any surface of the pin board 150, such as along the length of the pin board 150 at a front and back side as shown. In addition or alternatively, securing regions 154 may be arranged on the carriage 110, while securing features 140 may be arranged on the pin board 150. Accordingly, the position of the securing regions 154 may be selected to correspond to the position of the securing features 140 to enable the pin board 150 to be secured to the carriage 110.

Positioning feature 157 of the pin board 150 may have a complementary shape to the positioning features 117 of the receiving region or surface 116 and the positioning features 117, 157 may cooperate to aid in positioning of the pin board 115 in the carriage 110 so that the pins 151 align with the cell openings 220 once a tray 200 is positioned in the carriage 110. The positioning features 117, 157 may have various configurations and may include a protrusion/recess configuration, such as a dowel pin and a complementary shaped opening or recess.

The one or more handles 158 of the pin board 150 may generally be configured to be held by a user during positioning in and removal of the pin board 150 from the carriage 110. The handles 158 may be joined to or integrally formed by the pin board 150. Although the handles 158 are shown as being arranged along a width of the pin board 150, the handles 158 may be arranged at any position or surface of the pin board. In some examples, the handles 158 may not be present on the pin board 150, or may be removably joined thereto.

Turning to FIGS. 4A and 4B, a tray 200 for use in the extraction system 100 and a detail view of planting cells 202 of the tray 200 are respectively shown. The trays 200 may be pre-formed such as through injection molding, thermoforming, formed from polymerized styrene (e.g., Styrofoam™), metal stamped, and so on. The tray 200 may include a plurality of planting cells 202. Prior to the extraction operation, the planting cell 202 may be filled with an amount of planting material P, including plug media and seeds and/or seedlings growing therefrom along with root structures of such germinating seeds or seedlings.

As shown, each planting cell 202 may have approximately equal dimensions and the planting cells 202 may be arranged in rows and columns in the tray 200. In embodiments, the number of planting cells 202 across different trays may vary. For instance, larger trays may include a greater number of planting cells or may have a fewer number of larger planting. The tray 200 shown in FIG. 4A includes 128 planting cells arranged in 8 rows and 16 columns. Other example of tray configurations include 98 planting cells organized in 7 rows and 14 columns; 162 planting cells arranged in 9 rows and 18 columns. Accordingly, the number of planting cells 202 within each tray 200 may range from about 10 to about 600, although any number of planting cells may be included in a given tray. Specific embodiments may include about 10, 40, 50, 60, 72, 98, 128, 162, 242 or 512 planting cells 202 per tray 200. The planting cells 202 across different trays may vary, and for instance a tray with 512 planting cells 202 may have cell dimensions of ⅜ in. long x ⅜ in. wide x ¾ in. deep, while trays with fewer planting cells 202 may for example have the same, smaller or larger dimensions. As a whole, the collection of the plurality of planting cells 202 included in a tray 200 may generally define a tray perimeter that may be approximately square or rectangular in shape, such as that shown in FIG. 4A. Non-limiting examples of the dimensions of a tray are about 15 to 25 in. long, about 7 to 15 in. wide, and about 1 to 6 in. high, or about 21 in. long, about 11 in. wide, and about 2 in. high, although it will be understood that the tray may include other dimensions such as about 1, 2, 3, 4, 5, 6, 7, 8, 9, 10, 11, 12, 13, 14, 15, 16, 17, 18, 19, 20, 21, 22, 23, 24, 25, 26, 27, 28, 29, or 30 in. long, wide, or high, or any range between the stated numbers.

The tray 200 includes a skirt 206 surrounding the collection of planting cells 202 generally forming a perimeter wall. The skirt 206 of the tray 200 may generally have a height of about 0.3 to about 1.0 in., such as about 0.75 in., although it will be understood that the skirt may include other heights, such as about 0.2, 0.3, 0.4, 0.5, 0.6, 0.7, 0.8, 0.9, 1.0, 1.1, 1.2, 1.3, 1.4, 1.5, 1.6, 1.7, 1.8, 1.9, 2.0, 2.5, 3.0 in. high, or any range between the stated numbers. The skirt 206 may extend vertically downward from a top surface 210 of the tray where an open end 212 of each planting cells 202 may be defined. The planting cells may generally have a depth that is greater than the height of the skirt, but the skirt may instead have a depth that is greater than the height of the planting cells 202. The collection of planting cells 202 may thus be bounded together by the top surface 210 of the tray and surrounded by the skirt 206. According to the present disclosure, the support ribs 125, 130 may be adjustable relative to the frame 120 of the carriage to accommodate varying heights of the skirt 206, and the second support ribs 130 may support the tray 200 along the skirt 206.

The planting cells 202 may be defined by a vertical sidewall 214 extending along a depth thereof and terminating at an end wall 218 that for instance defines a bottom surface of the planting cell 202. Turning to FIG. 4B, illustrated is a cross-sectional view of two planting cells 202 of the tray 200. The planting cell 202 on the left side is shown with planting material P (e.g., plug media, seeds or a seedling and root structures thereof), while the interior of the planting cell 202 is shown on the right side. A drain opening 220 may be defined in the end wall 218 and referred to herein as a cell opening 220. The cell opening 220 of FIG. 4B is shown as a hole as having a circular shape, but may have a variety of shapes and sizes such as triangular, square, hexagonal, oval, and so on, and function to permit water to drain from the planting cell 202 over the course of growing seedling plants from the cells 202 of the tray 200. The opening 220 may have a diameter corresponding to the size of drain needed for water to exit the planting cells 202, which may be selected based on the type of planting material, plant, amount of time the tray 200 will used for a seedling growing operation, and so on, and for instance the diameter may range from about 0.1 in. to about 2.5 in., about 0.31 in. to 1.5 in., about 0.1, 0.25, 0.3, 0.5, 0.625, 0.75, 0.9, 1.0, 1.25, 1.5, 1.75, 2.0, 2.25, 2.5, 2.75, 3.0 in. or any range between the stated numbers. According to the present disclosure, the pins 151 of the pin board 150 may be configured to be received by the openings 220 of the planting cells 202. The pins 151 may have an external circumference that is at least slightly smaller than an internal circumference of the opening 220 of the planting cell 202.

The volume and/or shape of each cell within the tray 200 may vary. For instance, each cell may be approximately square, cylindrical or rectangular, and/or may define a volume ranging from about 30 to about 115 cm³ or about 50 cm³ or a cell volume of about 4 ml to about 700 ml, such as about 4, 5, 6, 7, 8, 9, 10, 20, 40, 50, 75, 100, 200, 300, 400, 500, 600, 700, or 800 ml. or any range between the stated numbers. In some examples, the planting cell dimensions may vary within a given seedling tray. For example, the planting cells may alternate in size and for instance such every second, third or fourth planting cell may be larger or smaller than each of the intervening cells.

The planting material P used to fill the planting cells 202 in a given tray may vary, and any suitable planting material may be employed. For instance, planting material may generally include plug media and one or more seeds or seedlings depending on a stage of growth in the planting cells 202. Plug media may include any planting media such as natural soil, foams, fiberglass, rock wool, fertilizer compositions, manure, soilless planting mixes, mineral compositions, nutrient compositions, vermiculite, peat, horticultural perlite, and/or any combination thereof. Seeds or seedlings may substantially be for any type of plant, and non-limiting examples may include plants for flowers, fruits, grasses, grains, leafy greens, cannabis, hemp, herbs, or any young plant.

The extraction system 100 may be used in manual extraction operations in which the system 100 extracts plugs of planting material P from their respective planting cells 202 of a tray 200. In an exemplary extraction operation, the pin board 150 and carriage 110 may initially be separate (FIG. 1B) and the pin board 150 may be inserted into the carriage 110 at the receiving region or surface 116 of the base 115 so that the pins 151 are facing the frame 120 (FIG. 5A). For instance, the pin board 150 may be inserted along a width of the carriage 110. The pin board 150 may be selected so that the pins 151 have a configuration that correspond to an arrangement of cells 202 and their cell openings 220 of a tray 200 that will undergo the extraction operation. The pin board 150 may be positioned in the receiving region or surface 116 by locating one or more positioning features 157 of the pin board 150 on or in corresponding positioning features 117 of the receiving region or surface 116 of the base 115. The pin board 150 may additionally or alternatively be secured to the carriage 110 by securing or more securing features 140 to securing regions 154. A tray 200 may be received in the interior region 121 of the frame 120 of the carriage 110 by inserting a first end of the tray 200 between the first and second support ribs 125, 130 and sliding the tray 200 into the interior region 121 until the first end and the sides of the tray 200 are positioned to rest along the recess 122 of the frame 120. In this position, the weight of the tray 200 may be supported by the frame 120 and at least one second support rib 130, and due to the strength of the compressible supports 136 of the compressible frame supports 135, the tray 200 may be held above the pins 151 of the pin board 150 in the first position (FIGS. 1A and 5C) of the extraction system 100. In the first position, the pins 151 of the pin board 150 may each be aligned with a cell opening 220 of a planting cell 202 of the tray 200 (FIGS. 1A and 5C). Where first support ribs 125 are adjustable, e.g., relative to the frame 120, these may be moved into positions so that the first support ribs 125 are arranged between rows of planting cells 202 (FIG. 1A). For instance, fasteners 126 may be loosened to permit the support ribs 125 to be slidable along a respective receiving slot 123 of the frame to a selected position and the fasteners 126 tightened to lock the support rib 125 into position. In addition or alternatively, the support ribs 125, 130 may be adjustably positioned as described herein. The compressible frame supports 135 may be compressed, such as by the user compressing and moving the frame 120 towards the base 115, e.g., by holding and pressing down evenly on opposite sides of the frame 120 such as by pressing down on the handles 145. During such movement, the compressible supports 136 may be compressed by the downward pressure being exerted by the user, and the pins 151 of the pin board 150 may enter the openings 220 of the planting cells 202 and contact the planting material P. The top surface 210 of the tray 200 may be supported by the first support ribs 125 preventing the tray 200 from being carried upwards by the pins 151. As a result, the pins 151 move further into the openings 220 of the planting cells 202 and the pins 151 may abruptly detach the planting material P from the vertical sidewalls 214 and end walls 218 of the planting cells 202 resulting in intact plugs of planting material P emerging from the open ends 212 of the planting cells 202 at the top of the tray 200 upon the carriage 110 reaching the second position (FIG. 5D), to thereby preserve the root structure and seedling in the plug material of the planting material P. Once the planting material P has been released from the planting cells 202, the user may release the frame 120 to remove the force exerted thereon resulting in the compressible supports 136 expanding to their original configuration and returning the frame 120 and thus the carriage 110 to its first position (FIGS. 1A and 5C) resulting in the planting material P settling back into the planting cells 202 in a loose fit. The tray 200 may be removed from the carriage 110 by sliding the tray 200 out from the support ribs 125, 130. With the planting material P loosely arranged in the planting cells 202, the planting material P is ready to be removed and transplanted for use in downstream growing operations. The various extraction operation steps described herein are non-limiting.

The extraction system 100 may provide benefits by providing the ability to remove a seedling or plants from the tray 200 without disrupting the root structure; pre-loosening plant material ahead of transplanting, e.g., manual or automated; reducing time and labor through the ejection of all plugs from the cells 202 in one simple motion; providing a modular configuration to the pin boards 150 resulting in a myriad of pin board/plug tray combinations, i.e., the system is not limited to one type of pin board 150; providing easily adjustable support ribs 125, 130 to accommodate wide range of tray 200 and planting cell 202 configurations; by providing a small, compact, light-weight design that is field deployable and easy to store, and may be constructed of materials that are easy to clean and sterilize.

The preceding description of certain embodiments is merely exemplary in nature and is in no way intended to limit the scope of the disclosure or its applications or uses. As provided in the detailed description of embodiments of the present systems and methods, reference is made to the accompanying drawings which form a part hereof, and which are shown by way of illustration specific embodiments in which the described systems and methods may be practiced. These embodiments are described in sufficient detail to enable those skilled in the art to practice presently disclosed systems and methods, and it is to be understood that other embodiments may be utilized, and that structural and logical changes may be made without departing from the spirit and scope of the disclosure. Moreover, for the purpose of clarity, detailed descriptions of certain features were not discussed when they would be apparent to those with skill in the art so as not to obscure the description of embodiments of the disclosure. The preceding detailed description is therefore not to be taken in a limiting sense, and the scope of the disclosure is defined only by the appended claims.

Accordingly, various changes may be made in the form, construction and arrangement of the components of the present disclosure without departing from the disclosed subject matter or without sacrificing all of its material advantages. The form described is merely explanatory, and it is the intention of the following claims to encompass and include such changes.

What is claimed is:

1. An extraction system, comprising:
a carriage comprising a base, a frame arranged atop the base, and a plurality of compressible frame supports joined between the base and the frame; and
a pin board comprising a plurality of pins joined to a base of the pin board, the pin board configured to be releasably secured to the base of the carriage,
wherein the carriage is configured such that the frame and the base of the carriage are movable relative to one another from a first position to a second position in which the plurality of compressible frame supports are compressed, and
wherein during movement from the first position to the second position, the pins of the pin board are configured to force planting material out of an open end of each of a plurality of planting cells of a tray held by the frame.

2. The extraction system of claim 1, wherein in the first position, the frame is configured to slidably receive the tray between at least one first support rib and at least one second support rib of the frame, the at least one first support rib and the at least one second support rib joined to a length of the frame and extending along a width of the frame, and wherein at least one of the first support rib or the second support rib is adjustably positionable.

3. The extraction system of claim 2, wherein one or more releasable fasteners join the frame to the at least one adjustably positionable support rib such that the at least one adjustably positionable support rib is movably adjustable along the length of the frame.

4. The extraction system of claim 2, wherein the at least one adjustably positionable support rib is height-adjustable relative to the frame.

5. The extraction system of claim 2, wherein the at least one adjustably positionable support rib is telescopic and configured to have an adjustable length.

6. The extraction system of claim 1, wherein the pin board is a first pin board, wherein the plurality of pins of the first pin board are non-removably fixed to the base of the first pin board, and wherein the extraction system comprises at least a second pin board configured to be releasably secured to the base of the carriage, the second pin board comprising a plurality of pins non-removably fixed to a base of the second pin board, and wherein a configuration of the pins of the first pin board differ from a configuration of the pins of the second pin board.

7. The extraction system of claim 1, wherein the pin board comprises a plurality of openings configured to removably receive the plurality of pins.

8. The extraction system of claim 1, wherein the base of the pin board comprises one of a securing feature or a securing region, and wherein the base of the carriage comprises another of the securing feature or the securing region, and wherein the securing feature and the securing region cooperate to secure the pin board to the carriage.

9. The extraction system of claim 8, wherein the base of the pin board comprises a first positioning feature and the base of the carriage comprises a second positioning feature, and wherein the first positioning feature and the second positioning feature are configured to engage to aid in positioning the pin board within the carriage.

10. The extraction system of claim 1, wherein the compressible frame supports are fixedly arranged on the base and slidably arranged on the frame such that the frame is movable towards the base during the movement from the first position to the second position.

11. A method of using an extraction system, comprising:
at a carriage, releasably securing a pin board on a base of the carriage in a first position of the carriage, the carriage comprising a frame arranged atop the base, and a plurality of compressible frame supports joined between the base and the frame, the pin board comprising a plurality of pins joined to a base of the pin board, wherein the plurality of compressible frame supports are uncompressed in the first position of the carriage; and
compressing the compressible frame supports such that the frame and the base are move relative to one another from the first position to a second position, wherein during compressing, the pins of the pin board force planting material out of an open end of each of a plurality of planting cells of a tray held by the frame of the carriage upon reaching the second position.

12. The method claim 11, wherein while the carriage is in the first position, further comprising:
slidably inserting the tray between at least one first support rib and at least one second support rib of the frame, the at least one first support rib and the at least one second support rib joined to a length of the frame and extending along a width of the frame; and
adjustably positioning at least one of the first support rib or the second support rib.

13. The method claim 12, wherein adjustably positioning comprises releasably joining the at least one adjustably positionable support rib to the frame such that the adjustably positionable support rib is movably adjustable along the length of the frame.

14. The method claim 12, wherein adjustably positioning comprises adjusting a height of the at least one adjustably positionable support rib relative to the frame.

15. The method claim 12, wherein adjustably positioning comprises adjusting a length of the at least one adjustably positionable support rib.

16. The method claim 11, wherein the pin board is a first pin board, and while the carriage is in the first position, further comprising: removing the first pin board and releasably securing a second pin board to the base, the second pin board comprising a plurality of pins non-removably fixed to a base of the second pin board, and wherein a configuration of the pins of the first pin board differ from a configuration of the pins of the second pin board.

17. The method claim 11, wherein prior to releasably securing the pin board on the base of the carriage, further comprising inserting the plurality of pins into a plurality of openings of the pin board.

18. The method claim 11, wherein releasably securing the pin board to the base of the carriage comprises securing a securing feature to a securing region, wherein the base of the pin board comprises one of the securing feature or the securing region, and the base of the carriage comprises another of the securing feature or the securing region.

19. The method claim 18, wherein prior to releasably securing, further comprising locating the base of the pin board on the base of the carriage by engaging a first positioning feature of the pin board with a second positioning feature of the base of the carriage.

20. The method claim 11, wherein the compressible frame supports are fixedly arranged on the base and slidably arranged on the frame such that the frame is movable towards the base during movement from the first position to the second position.
